(19) United States
(12) Patent Application Publication
(10) Pub. No.: US 2017/0120765 A1
(43) Pub. Date: May 4, 2017

(54) CONTACTLESS POWER TRANSFER SYSTEM AND VEHICLE

(71) Applicant: TOYOTA JIDOSHA KABUSHIKI KAISHA, Toyota-shi, Aichi-ken, (JP)

(72) Inventor: Shinji ICHIKAWA, Toyota-shi (JP)

(73) Assignee: TOYOTA JIDOSHA KABUSHIKI KAISHA, Toyota-shi, Aichi-ken (JP)

(21) Appl. No.: 15/039,560

(22) PCT Filed: Nov. 17, 2014
(86) PCT No.: PCT/IB14/02444

§ 371 Date: May 26, 2016

(30) Foreign Application Priority Data
Nov. 27, 2013 (JP) 2013-244992

(51) Int. Cl. B60L 11/18; H02J 7/00; H02J 7/02

(52) U.S. Cl. CPC B60L 11/1825; B60L 11/182; H02J 7/025; H02J 7/0021; B60L 2230/16; H02J 2007/0096

(57) ABSTRACT

A contactless power transfer system includes a vehicle and a charging station. The charging station includes a first communication unit and a power transferring unit. The vehicle includes a second communication unit configured to communicate with the first communication unit, a power receiving unit configured to contactlessly receive power from the power transferring unit, a display unit for indicating a relative positional relationship between the power receiving unit and the power transferring unit, and a control unit (vehicle ECU) controlling the second communication unit the power receiving unit and the display unit. The vehicle ECU starts display of a relative positional relationship between the power receiving unit and the power transferring unit, on the display unit, when the second communication unit receives a broadcast signal from the first communication unit.

### BACKGROUND OF THE INVENTION

1. Field of the Invention

This invention relates to a contactless power transfer system and a vehicle.

2. Description of Related Art

Japanese Patent Application Publication No. 2011-015549 (JP 2011-015549 A) discloses a contactless power system which transfers electric power to a charging station from a vehicle, in a contactless fashion. A problem with contactless charging systems is the alignment of the power transferring unit of the charging station and the power receiving unit of the vehicle in order to raise the efficiency of power transfer and reception.

JP 2011-015549 A discloses a parking assistance device wherein, when executing this alignment, a first image captured by a camera is displayed when the distance between the vehicle and the target parking position is smaller than a prescribed value, whereafter, a second image including information relating to alignment which is not obtained with the first image is created and starts to be displayed on a display unit.

In contactless charging, the alignment with respect to the power transferring unit is important, and therefore it is necessary to transmit information about the positional relationship with respect to the power transferring unit, appropriately to the driver, before parking, via a user interface.

However, JP 2011-015549 A mentioned above does not describe the display timing of the second image which indicates this information. When the timing of the display of this image is late, then the driver may not be able to carry out alignment using the image. On the other hand, when the timing of the display of the image is too early, then the operability of the navigation screen becomes worse, for instance, it becomes impossible to display touch panel operating buttons, due to the fact that the image relating to the power transferring unit is being projected on the navigation screen. In particular, when information about the positional relationship is displayed at all times, then this means that an excessive amount of information is being presented.

### SUMMARY OF THE INVENTION

Therefore, a contactless power transfer system and a vehicle are provided, whereby alignment can be assisted in a manner that avoids, as far as possible, impairment to the operability of the vehicle.

According to an aspect of this invention, a contactless power transfer system as indicated below is provided. More specifically, a contactless power transfer system includes a vehicle and a charging station. The charging station includes a first communication unit and a power transferring unit. The vehicle includes a second communication unit, a power receiving unit, a display unit and an electronic control unit, (ECU). The second communication unit is configured to communicate with the first communication unit. The power receiving unit is configured to contactlessly receive electric power from the power transferring unit. The display unit is configured to indicate a relative positional relationship between the power receiving unit and the power transferring unit. The ECU is configured to control the second communication unit, the power receiving unit and the display unit. When a vehicle parking region is a region in which the vehicle is positioned in a state where the power receiving unit is disposed so as to face a power transferring unit, the first communication unit is configured to output a first signal so that the signal reaches the outside of the vehicle parking region. The second communication unit is configured to receive from outside the vehicle parking region a signal from the charging station. The ECU is configured to start a display of the positional relationship on the display unit, when the second communication unit receives the first signal.

According to the contactless power transfer system having the composition described above, a navigation screen, for example, is displayed on the display unit and unnecessary information is not displayed, until the second communication unit of the vehicle receives a signal from the first communication unit of the charging station. The signal from the first communication unit is a broadcast signal, for example, and the display of the positional relationship is started upon receiving this signal. Consequently, the image starts to be displayed when the vehicle is at a position suitably distanced from the parking bays, and therefore the driver is able to carry out alignment of the power reception device and the power transfer device, based on the displayed image. In other words, the image is displayed from a position at a suitable distance from the parking bays, and the image is not displayed when the vehicle is in a position at a greater distance from the parking bays. Therefore, the aforementioned image is not displayed on the display unit, for instance, when the vehicle has left the charging station and is travelling along a road, and therefore the screen is prevented from becoming more complex.

In the contactless power transfer system described above, a plurality of parking bays may be provided in the charging station, and the first communication unit of the charging station may be configured to output the first signal when determination is made that the vehicle is not parked over at least one of the power transferring unit.

Furthermore, in the contactless power transfer system described above, the charging station may include a detection unit configured to detect the vehicle positioned over the power transferring unit.

According to the composition described above, the vehicle is guided inside the charging station when a parking bay is free.

Furthermore, in the contactless power transfer system described above, the second communication unit of the vehicle may be configured to output a second signal upon receiving the first signal, and the ECU may be configured to transfer electric power from the power transferring unit to the power receiving unit when the first communication unit of the charging station receives the second signal, and the electronic control unit is configured to display a positional relationship between the power receiving unit and the power transferring unit on the display unit based on a received voltage generated by the electric power received by the power receiving unit.

According to the contactless power transfer system having composition described above, since power transfer is actually performed between the power transferring unit and the power receiving unit, and the vehicle can be aligned in accordance with the results thereof, then the vehicle can be charged in a reliable fashion.

Furthermore, in the contactless power transfer system described above, the vehicle may include a contactless charging switch operated by a user; and the ECU may be configured to output the second signal to the second communication unit and implement a display on the display unit when the second communication unit receives the first signal while the contactless charging switch is on.

According to the contactless power transfer system having the composition described above, for example, when a user wishes to charge the vehicle, then by switching on the contactless charging switch, an indicator is displayed on the display unit and the user is able to align the power receiving unit and the power transferring unit based on the received voltage.

Furthermore, in the contactless power transfer system described above, the charging station may include a plurality of power transferring units. The ECU may implement a pairing process with the charging station in order to make the charging station identify which one of the plurality of power transferring units the power receiving unit has been aligned with the one of the plurality of power transferring units, when alignment of the power receiving unit with any one of the plurality of power transferring units has been completed after starting the display of the positional relationship on the display unit.

By implementing processing of this kind, the charging station is able to identify the power transferring unit with which the vehicle has been aligned, even in a charging station which has a plurality of power transferring units.

Furthermore, in the contactless power transfer system described above, the pairing process may include processing in which a plurality of mutually different pattern power transfers are implemented respectively from the plurality of power transferring units. The pairing process may include processing in which a signal corresponding to the pattern power transfer received by the power receiving unit is transmitted from the second communication unit to the first communication unit.

Furthermore, in the contactless power transfer system described above, the plurality of pattern power transfers may be power transfers in which electric power is transferred so as to repeat on and off switching in mutually different patterns, during a prescribed time period.

Furthermore, the plurality of pattern power transfers may be power transfers in which electric power is transferred for mutually different power transfer times, during a prescribed time period.

Furthermore, the ECU may not display an image representing the positional relationship on the display unit, before a communication is established between the first communication unit and the second communication unit.

Consequently, since an image relating to alignment is displayed in a state where there is an increased possibility of charging, and an unnecessary image is not displayed before a communication is established, then even when alignment assistance is implemented, there is reduced possibility of impairing the operations of the navigation system that the user wishes to perform.

According to a further aspect of this invention, a vehicle is provided which is configured to be able to receive electric power from a charging station including a first communication unit and a power transferring unit. The vehicle includes a second communication unit, a power receiving unit, a display unit and an ECU. The second communication unit is configured to communicate with the first communication unit, from a position that is distant from the parking bay. The power receiving unit is configured to contactlessly receive electric power from the power transferring unit. The display unit is configured to indicate a relative positional relationship between the power receiving unit and the power transferring unit. The ECU is configured to control the second communication unit, the power receiving unit and the display unit. When a parking bay is a region in which the vehicle is positioned in a state where the power receiving unit is disposed so as to face a power transferring unit, the first communication unit is configured to output a first signal so that the signal reaches the outside of the parking bay. The second communication unit is configured to receive from outside the parking bay a signal from the charging station. The ECU is configured to start a display of the positional relationship on the display unit, when the second communication unit receives the first signal.

According to the contactless power transfer system having the composition described above, a navigation screen, for example, is displayed on the display unit and unnecessary information is not displayed, until the second communication unit of the vehicle receives a signal from the first communication unit of the charging station. The signal from the first communication unit is a broadcast signal, for example, and the display of the positional relationship is started upon receiving this signal. Consequently, the image starts to be displayed at a position suitably distanced from the parking bays, and therefore the driver is able to carry out alignment of the power reception device and the power transfer device, based on the displayed image. In other words, the image is displayed from a position at a suitable distance from the parking bays, and the image is not displayed when the vehicle is in a position at a greater distance from the parking bays. Therefore, the aforementioned image is not displayed on the display unit, for instance, when the vehicle has left the charging station and is travelling along a road, and therefore the screen is prevented from becoming more complex.

According to this invention, when a driver carries out charging, necessary information is displayed on a display unit at a suitable timing, and therefore it is possible to achieve both good operability of the vehicle and convenient parking assistance.

### BRIEF DESCRIPTION OF THE DRAWINGS

Features, advantages, and technical and industrial S significance of exemplary embodiments of the invention will be described below with reference to the accompanying drawings, in which like numerals denote like elements, and wherein:

FIG. 1 is a general schematic drawing of a contactless power transfer system which is one example of an embodiment of this invention;

FIG. 2 is a diagram illustrating a situation where a vehicle is parked in a parking position inside a charging station;

FIG. 3 is a diagram illustrating a state after completing alignment of a power transferring unit of the charging station and the power receiving unit of the vehicle;

FIG. 4 is a diagram for describing the path of a magnetic flux between the power transferring unit and the power receiving unit;

FIG. 5 is a diagram showing the Y-direction offset between the power transferring unit and the power receiving unit;

FIG. 6 is a diagram showing the X-direction offset between the power transferring unit and the power receiving unit;

FIG. 7 is a flowchart for describing an overview of the processing which is implemented by the vehicle and the charging station when contactless power transfer is carried out;

FIG. 8 is a timing chart which represents change in the transferred power and the received voltage, which vary over the course of the processing in FIG. 7;

FIG. 9 is a diagram showing a state of carrying out alignment while the vehicle is reversing;

FIG. 10 is a diagram showing a state where an indicator is displayed on the display unit;

FIG. 11 is a diagram for describing changes in the indicator display; and

FIG. 12 is a diagram for describing modifications of the pairing process in this embodiment.

### DETAILED DESCRIPTION OF EMBODIMENTS

Below, embodiments of this invention are described in detail with reference to the accompanying drawings. Portions which are the same or equivalent are labelled with the same reference numerals and description thereof is not repeated.

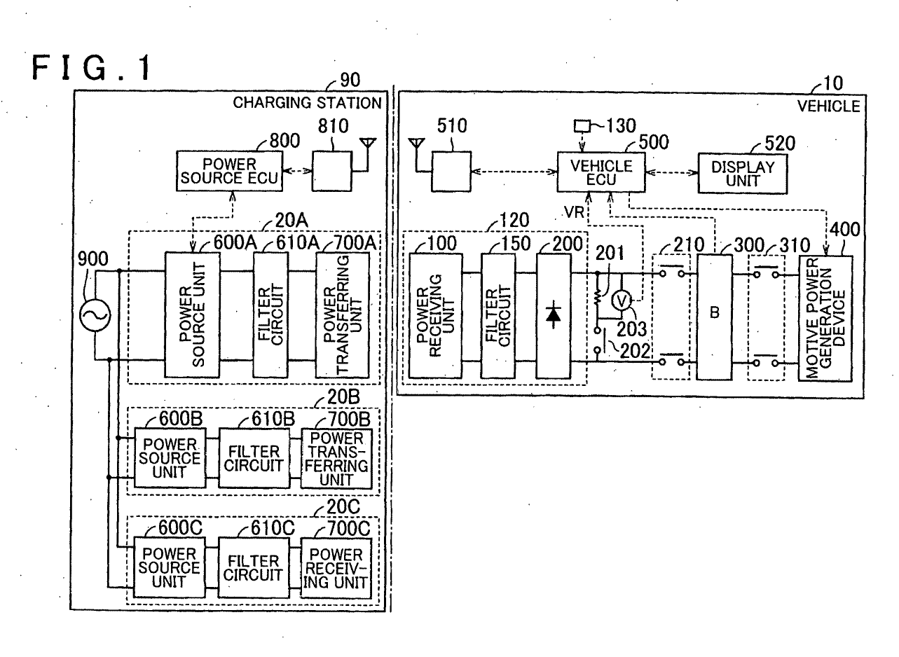

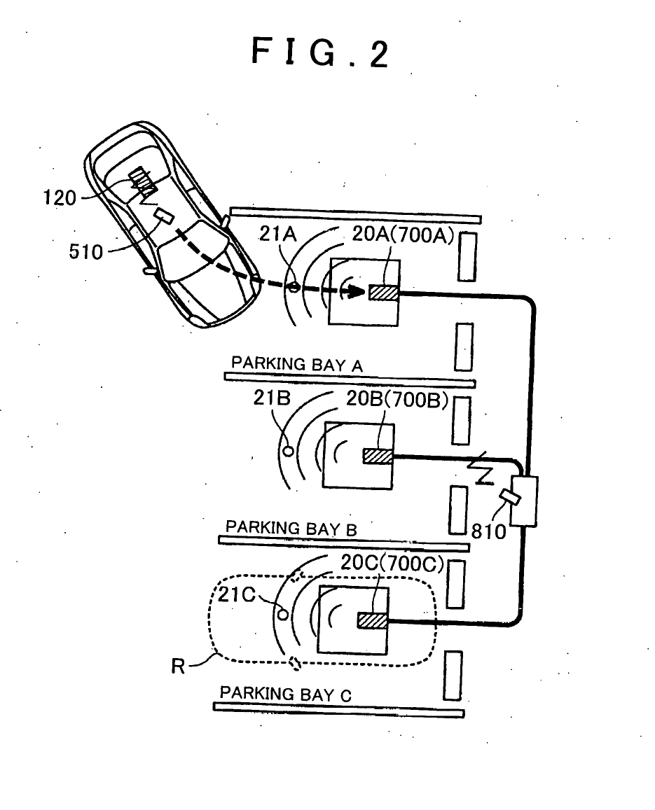

FIG. 1 is a general schematic drawing of a contactless power transfer system which is one example of an embodiment of this invention. FIG. 2 is a diagram illustrating a situation where a vehicle is parked in a parking position inside a charging station. To begin, an overall explanation of this embodiment will be described with reference to FIG. 1 and FIG. 2.

The description below refers to FIG. 1 and FIG. 2. The contactless power transfer system of this embodiment includes a vehicle 10 and a charging station 90. The charging station 90 includes a first communication unit 810, parking bays A to C, and power transferring units 700A to 700C which are provided respectively in the parking bays A to C. The “vehicle parking region R” in FIG. 2 indicates a region where the vehicle 10 is aligned when the vehicle 10 is parked, in such a manner that the power receiving unit 100 of the vehicle 110 opposes any one of the power transferring units 700A to 700C of the charging station 90.

In FIG. 2, the vehicle parking region relating to the power transferring unit 700C of the power transfer device 20C is depicted, but needless to say, the power transferring units 700A and 700B of power transfer devices 20A and 20B also have respective vehicle parking regions.

The first communication unit 810 is able to transmit a signal so as to reach inside the vehicle parking region R and outside the vehicle parking region R. More specifically, the transmission area of the first communication unit 810 is a range having a radius of 5 m to 10 m, for example, centred on the first communication unit 810.

In other words, the first communication unit 810 transmits a signal that reaches up to not only the parking bays A to C but also a position several metres distant from the parking bays A to C. When it is supposed that a vehicle 10 is situated within the parking bays A to C or within a range of several metres from the parking bays A to C, then the vehicle 10 is able to receive a signal from the charging station 90.

The vehicle 10 is provided with: a second communication unit 510 which is capable of transmitting a signal to the charging station and reception from the charging station, not only within the parking bays, but also from outside the parking bays A to C (for example, a position distanced by approximately 5 to 10 m); a power receiving unit 100 which is composed so as to contactlessly receive electric power from the power transferring units 700A to 700C; a display unit 520 for displaying the relative positions between the power receiving unit 100 and the power transferring units 700A to 700C; and an ECU (vehicle ECU 500) which is a control unit that controls the second communication unit 510, the power receiving unit 100 and the display unit 520.

The vehicle ECU 500 starts to display the relative positional relationships of the power receiving unit 100 and the power transferring units 700A to 700C, on the display unit 520, upon receiving a broadcast signal (first signal) which indicates that charging is possible as indicated below. The vehicle 10, for example, receives the broadcast signal described above, at a position approximately several meters distant from the parking bays A to C.

According to the composition described above, a navigation screen, for example, is displayed on the display unit 520 until the second communication unit 510 receives the broadcast signal, and unnecessary information is not displayed. The display of the positional relationship is started upon receiving the broadcast signal indicated above. Consequently, the image starts to be displayed at a position suitably distanced from the parking bays A to C, and therefore the driver is able to carry out alignment of the power reception device and the power transfer device, based on the displayed image. In other words, the image is displayed from a position at a suitable distance from the parking bays, and the image is not displayed when the vehicle 10 is in a position at a greater distance from the parking bays. Therefore, the aforementioned image is not displayed on the display unit, for instance, when the vehicle has left the charging station and is travelling along a road, and therefore the screen is prevented from becoming more complex.

Desirably, the charging station 90 includes sensors 21A to 21C which are provided in the respective parking bays A to C. The sensors 21A to 21C detect the presence or absence of a vehicle 10 parked in the respective parking bays A to C. The charging station 90 sends the aforementioned broadcast signal to the peripheral area, when it is determined based on the outputs from the sensors 21A to 21C that a vehicle 10 has not been parked in at least one of the parking bays A to C. On the other hand, the charging station does not send the broadcast signal to the peripheral area when it is determined that a vehicle 10 has been parked in all of the parking bays A to C.

According to the composition described above, a vehicle 10 is guided into the charging station 90 when there is a free parking bay.

Desirably, the vehicle 10 transmits a weak electric power request signal (second signal) to the peripheral area, as described hereinafter, upon receiving the broadcast signal from the charging station 90. This signal is transmitted so as to reach a range of approximately 5 m to 10 m, centred on the vehicle 10. Therefore, even when the vehicle 10 is aligned outside the parking bays A to C, the charging station 90 is still able to receive the weak power request signal.

Upon receiving the weak power request signal, the charging station 90 supplies a weak electric power at least to the transfer devices 20A to 20C provided in the parking bays A to C which are free. The vehicle ECU 500 displays the positional relationship between the power receiving unit 100 and any of the power transferring units 700A to 700C, on the display unit 520, based on a received voltage VR which is generated by the power received by the power receiving unit 100.

According to the composition described above, since power transfer is actually performed between the power transferring units and the power receiving unit, and the vehicle can be aligned in accordance with the results thereof, then the vehicle can be charged in a reliable fashion.

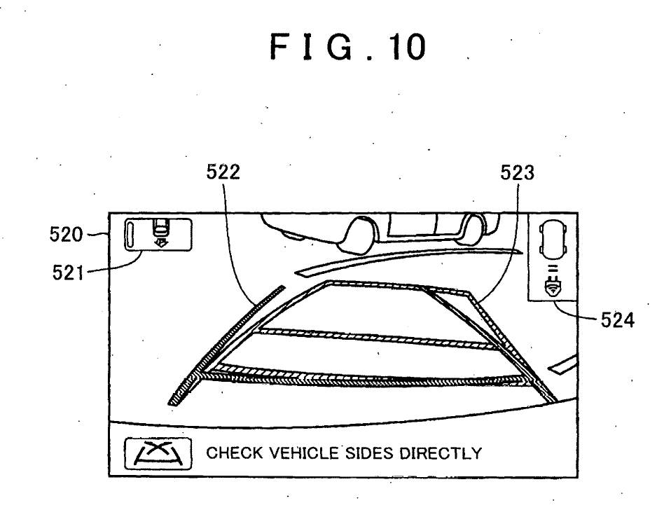

Desirably, the vehicle 10 includes a contactless charging switch 130 which is operated by a user, and when the broadcast signal is received while the contactless charging switch 130 is ON, then the weak power request signal output to the charging station 90, and an indicator 524 (see FIG. 10), are displayed on the display unit 520.

According to the composition described above, for example, when a user wishes to charge the vehicle, then by switching on the contactless charging switch, an indicator is displayed on the display unit and the user is able to align the power receiving unit and the power transferring unit based on the received voltage.

Desirably, the weak power request signal is transferred after receiving the broadcast signal, and the indicator 524 is subsequently displayed on the display unit 520, but it is also possible to display the indicator 524 on the display unit 520 after receiving the broadcast signal, and to then subsequently transmit the weak power request signal.

Desirably, the charging station 90 includes a plurality of power transferring units 700A to 700C. When the alignment of the power receiving unit 100 with any one of the plurality of power transferring units 700A to 700C has been completed after starting the display of the positional relationship on the display unit 520, the vehicle ECU 500 implements a pairing process with the charging station 90 in order to identify, to the charging station 90, which one of the plurality of power transferring units 700A to 700C the power receiving unit 100 has been aligned with.

By implementing processing of this kind, the charging station is able to identify the power transferring unit which has carried out alignment, even in the charging station 90 which has a plurality of power transferring units 700A to 700C.

Desirably, the pairing process includes processing in which a plurality of mutually different pattern power transfers are sent respectively from each of a plurality of power transferring units 700A to 700C, and a signal corresponding to the pattern power transfer received by the power receiving unit 100 is transmitted from the second communication unit 510 to the first communication unit 810.

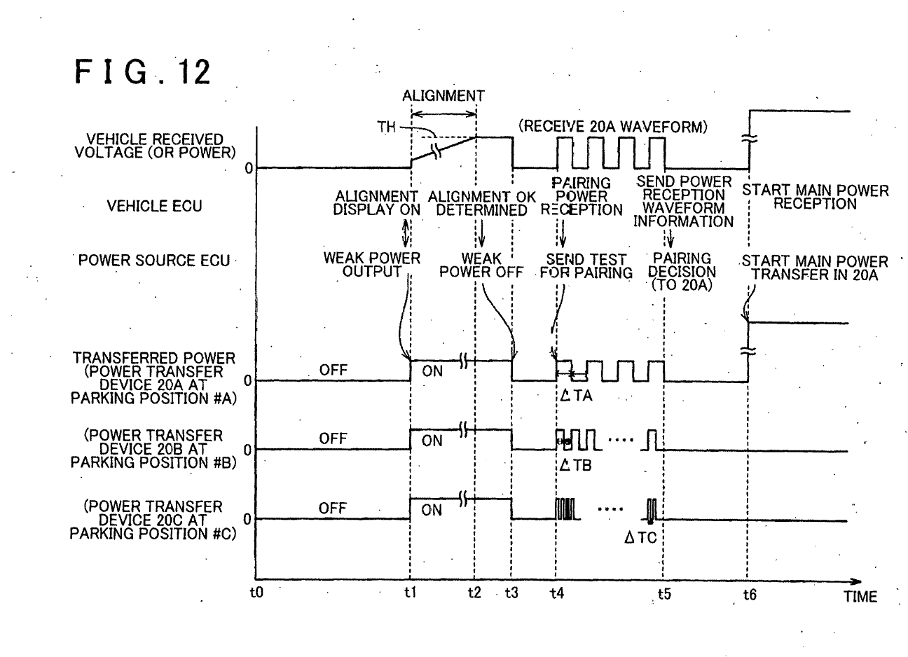

More desirably, the plurality of pattern power transfers are power transfers in which electric power is transferred so as to repeat an on and off switching in mutually different patterns, during a prescribed time period (see FIG. 12).

More desirably, the plurality of pattern power transfers are power transfers in which electric power is transferred for mutually different power transfer times, during a prescribed time period (see FIG. 12).

Preferably, the vehicle ECU 500 does not display an image representing the positional relationship on the display unit 520, before a communication is established between the first communication unit 810 and the second communication unit 510.

Consequently, since an image relating to alignment is displayed in a state where there is an increased possibility of charging, and an unnecessary image is not displayed before a communication is established, then even when alignment assistance is implemented, there is reduced possibility of impairing the operations of the navigation system that the user wishes to perform.

Next, the detailed composition of the contactless power transfer system will be described further. Referring to FIG. 1, the contactless power transfer system according to embodiment is constituted by a vehicle 10 which is fitted with a power reception device 120 composed so as to be able to contactlessly receive power, and a charging station 90 equipped with power transfer devices 20A, 20B and 20C which transfer electric power to the power receiving unit 100 from outside the vehicle.

The vehicle 10 is provided with: a power reception device 120, a contactless charging switch 130, a power storage device 300, a motive power generation device 400, a second communication unit 510, a vehicle ECU 500 and a display unit 520. The power reception device 120 includes a power receiving unit 100, a filter circuit 150 and a current rectifying unit 200.

The charging station 90 includes an external power source 900, the power transfer devices 20A, 20B and 20C, the first communication unit 810 and an ECU (power source ECU 800), which is a control unit. The power transfer devices 20A, 20B and 20C respectively include power source units 600A, 600B and 600C, filter circuits 610A, 610B and 610C and power transferring units 700A, 700B and 700C.

For instance, as shown in FIG. 2, the power transfer devices 20A, 20B and 20C are respectively provided on the ground surface or inside the ground of the parking bays A, B and C and the power reception device 120 is disposed below the vehicle body. The location of the arrangement of the power reception device 120 is not limited to this. For example, in the case of a charging station in which the power transfer devices 20A, 20B and 20C are provided above the vehicle 10, the power reception device 120 may be provided in the upper part of the vehicle body.

The power receiving unit 100 includes a secondary coil for contactlessly receiving, electric power (alternating current (AC)) output from any one of the power transferring units 700A, 700B and 700C of the power transfer devices 20A, 20B and 20C. The power receiving unit 100 outputs the received electric power to the current rectifying unit 200. The current rectifying unit 200 rectifies the AC power received by the power receiving unit 100 and outputs the power to the power storage device 300. The filter circuit 150 is provided between the power receiving unit 100 and the current rectifying unit 200, and suppresses harmonic noise generated upon receiving power from the power transferring units 700A, 700B and 700C. The filter circuit 150 is composed, for example, by an inductor/condenser (LC) filter including an inductor and a capacitor.

The power storage device 300 is a rechargeable direct current (DC) power source, and is composed by a secondary cell, such as a lithium oil cell or a nickel hydrogen cell, for example. The voltage of the power storage device 300 is approximately 200 V, for example. As well as storing power output from the current rectifying unit 200, the power storage device 300 also stores electric power generated by the motive power generation device 400. The power storage device 300 supplies the stored electric power to the motive power generation device 400. It is also possible to employ a capacitor having a large capacitance as the power storage device 300. Although not depicted in particular in the drawings, it is possible to provide a DC-DC converter that adjusts the output voltage of the current rectifying unit 200, between the current rectifying unit 200 and the power storage device 300.

The motive power generation device 400 generates travel drive power for the vehicle 10 by using the electric power stored in the power storage device 300. Although not depicted in particular in the drawings, the motive power generation device 400 includes, for example, an inverter which receives electric power from the power storage device 300, a motor which is driven by the inverter, and drive wheels, and the like, which are driven by the motor, and the like. The motive power generation device 400 may include a generator for charging the power storage device 300, and an engine capable of driving the generator.

The vehicle ECU 500 includes a central processing unit (CPU), a storage device, an input/output buffer, and the like (none of which is shown in the drawings), and inputs signals from various sensors, outputs control signals to respective devices, and implements control of respective devices in the vehicle 10. For example, the vehicle ECU 500 executes travel control of the vehicle 10 and charging control of the power storage device 300. These control processes are not limited to software-based processes, and may be implemented by dedicated hardware (electronic circuit).

A relay 210 is provided between the current rectifying unit 200 and the power storage device 300. The relay 210 is switched on by the vehicle ECU 500 during charging of the power storage device 300 by the power transfer devices 20A, 20B and 20C. Furthermore, a system main relay (SMR) 310 is provided between the power storage device 300 and the motive power generation device 400. The SMR 310 is switched on by the vehicle ECU 500 when start-up of the motive power generation device 400 is requested.

Furthermore, a relay 202 is provided between the current rectifying unit 200 and the relay 210. The voltage VR at either end of the resistance 201 which is connected in series with the relay 202 is detected by the voltage sensor 203, and is sent to the vehicle ECU 500.

The vehicle ECU 500 communicates with the first communication unit 810 of the charging station 90 by using the second communication unit 510, when charging the power storage device 300 by the power transfer devices 20A, 20B and 20C, and exchanges information, such as the starting and stopping of charging, the power reception status of the vehicle 10, and so on, with the power source ECU 800.

The description below refers to FIG. 1 and FIG. 2. The vehicle 10 or the charging station 90 determines that the position of the secondary coil in the power reception device 120 is aligned with the position of the primary coil inside the power transfer device 20A, based on a vehicle-mounted camera (not illustrated) and the reception intensity, and the like, of the test power transfer (transmission at weak power) in the power transferring unit 700A. This is reported to the user by the display unit 520. The user moves the vehicle 10 in such a manner that a positional relationship which is favourable for transmission and reception of power is achieved between the power reception device 120 and the power transfer device 20A, based on the information obtained from the display unit 520. It is not absolutely necessary for the user to operate the steering wheel and the accelerator, and the vehicle 10 may be moved automatically to align the positions, with the user observing this operation by the display unit 520. An indicator such as that shown in FIG. 10 is shown on the display unit 520 in order to depict the information, for example.

Referring again to FIG. 1, the power source units 600A, 600B and 600C receive electric power from an external power source 900, such as a commercial power source, and generate AC power having a prescribed transmission frequency.

The power transferring units 700A, 700B and 700C include a primary coil for contactlessly transferring power to the power receiving unit 100. The power transferring units 700A, 700B and 700C receive AC power having a transmission frequency from the power source units 600A, 600B and 600C, and contactlessly transfer power to the power receiving unit 100 of the vehicle 10, via the electromagnetic field which is generated about the power transferring units 700A, 700B and 700C.

The filter circuits 610A, 610B and 610C are provided between the power source units 600A, 600B and 600C and the power transferring units 700A, 700B and 700C, and thereby suppress harmonic noise generated by the power source units 600A, 600B and 600C. The filter circuits 610A, 610B and 610C are each composed by an LC filter including an inductor and a capacitor.

The power source ECU 800 includes a CPU, a storage device, an input/output buffer, and the like (none of which is shown in the drawings), and inputs signals from various sensors, outputs control signals to respective devices, and implements control of respective devices in the charging station 90. For example, the power source ECU 800 controls switching of the power source units 600A, 600B and 600C in such a manner that the power source units 600A, 600B and 600C generate AC power having a transmission frequency. These control processes are not limited to software-based processes, and may he implemented by dedicated hardware (an electronic circuit).

The power source ECU 800 communicates with the second communication unit 510 of the vehicle 10 by using the first communication unit 810, when transferring power to the vehicle 10, and exchanges information about the starting/stopping of charging, the power reception status of the vehicle 10, and so on, with the vehicle 10.

An AC power having a prescribed transmission frequency is supplied from the power source units 600A, 600B and 600C to the power transferring units 700A, 700B and 700C via the filter circuits 610A, 610B and 610C. The power transferring units 700A, 700B and 700C and the power receiving unit 100 of the vehicle 10 each include a coil and a capacitor, and are designed so as to resonate at the transmission frequency. The Q value which indicates the resonant frequency of the power transferring units 700A, 700B and 700C and the power receiving unit 100 is desirably no less than 100.

When AC power is supplied from the power source units 600A, 600B and 600C to the power transferring units 700A, 700B and 700C via the filter circuits 610A, 610B and 610C, then energy (electric power) is transferred to the power receiving unit 100 from any of the power transferring units 700A, 700B and 700C, via the electro-magnetic field which is formed between the primary coil included in any one of the power transferring units 700A, 700B and 700C and the secondary coil of the power receiving unit 100. The energy (electric power) transferred to the power receiving unit 100 is supplied to the power storage device 300 via the filter circuit 150 and the rectifying unit 200.

Although not depicted in the drawings, it is possible to provide an insulating transformer between the power transferring units 700A, 700B and 700C and the power source units 600A, 600B and 600C (for example, between the power transferring units 700A, 700B and 700C and the filter circuits 610A, 610B and 610C). Furthermore, in the vehicle 10, an insulating transformer may be provided between the power receiving unit 100 and the current rectifying unit 200 (for example, between the power receiving unit 100 and the filter circuit 150).

The primary coils included in the power transferring units 700A, 700B and 700C and the secondary coil included in the power receiving unit 100 are polarized type coils in which a magnetic flux exits from one end to the other end.

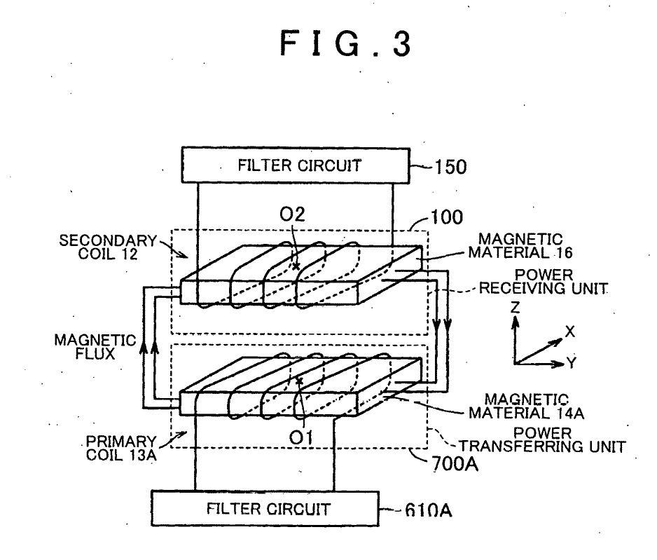

When the vehicle 10 is parked in a parking bay A, then as shown in FIG. 3, electric power is transferred by the power transferring unit 700A and the power receiving unit 100.

FIG. 3 is a diagram illustrating a state after alignment of the power transferring unit 700A and the power receiving unit 100 has been completed. The power transferring unit 700A includes a primary coil 13A, and a flat plate-shaped magnetic material (core) 14A about which the primary coil 13A is wound. The power receiving unit 100 includes a secondary coil 12 and a flat plate-shaped magnetic material (core) 16 about which the secondary coil 12 is wound.

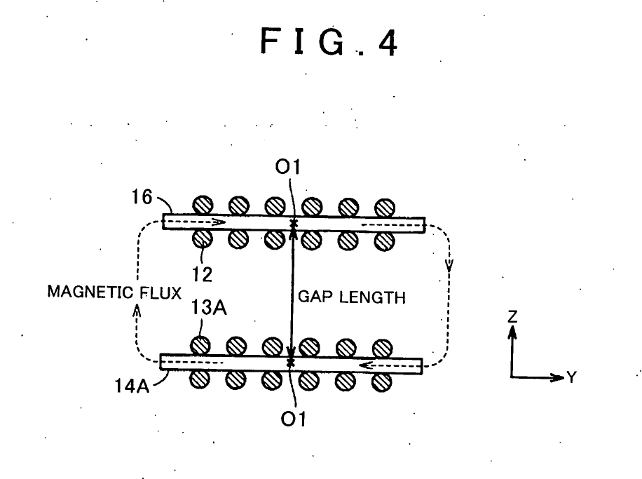

FIG. 4 is a diagram for illustrating the path of the magnetic flux between the power transferring unit 700A and the power receiving unit 100.

Referring to FIG. 3 and FIG. 4, a magnetic flux passes through the central portion of the coils 13A and 12 wound about the magnetic materials 14A and 16 (the interior of the magnetic material). The magnetic flux which has passed through the interior of the magnetic material 14A from one end towards the other end of the primary coil 13A is directed towards one end of the secondary coil 12, passes through the interior of the magnetic material 16 from one end towards the other end of the secondary coil 12, and returns to one end of the primary coil 13A.

The centre of gravity O1 of the magnetic material (core) 14A coincides with the centre of gravity O1 of the primary coil 13A, and the centre of gravity O2 of the magnetic material (core) 16 coincides with the centre of gravity O2 of the secondary coil 12. The magnetic material 14A and the magnetic material 16 are disposed perpendicularly in the vertical direction (Z direction). Here, the front/rear direction of the vehicle 10 is called the X direction and the left/right direction of the vehicle 10 is called the Y direction. The centre of gravity O1 of the core 14A of the primary coil 13A is the point of origin of the three-dimensional co-ordinates (X, Y, Z).

The vertical-direction (Z-direction) component of the distance between the centre of gravity O1 of the core 14A of the primary coil 13A and the centre of gravity O2 of the core 16 of the secondary coil 12 is called the “gap length”. When the positions of the centre of gravity O1 of the core 14A of the primary coil 13A and the centre of gravity O2 of the core 16 of the secondary coil 12 coincide with each other in the horizontal direction (in other words, if the X co-ordinates and the Y co-ordinates coincide), then the distance between the centre of gravity O1 of the core 14A of the primary coil 13A and the centre of gravity O2 of the core 16 of the secondary coil 12 is the gap length.

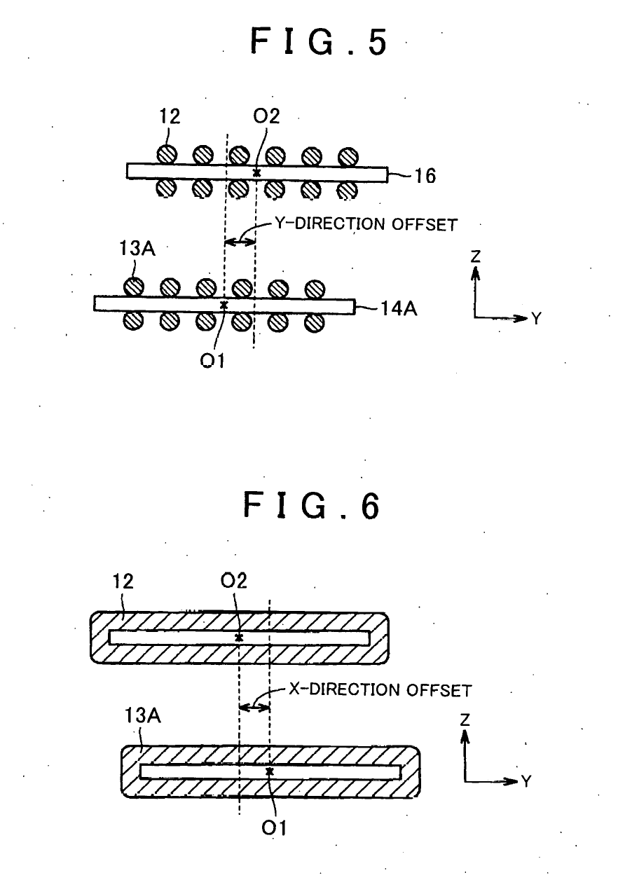

FIG. 5 is a diagram showing the Y-direction offset. FIG. 6 is a diagram showing the X-direction offset. The offset is described here with reference to FIG. 5 and FIG. 6.

The Y-direction offset is the Y-direction component of the distance between the centre of gravity O1 of the core 14A of the primary coil 13A and the centre of gravity O2 of the core 16 of the secondary coil 12. The X-direction offset is the X-direction component of the distance between the centre of gravity O1 of the core 14A of the primary coil 13A and the centre of gravity O2 of the core 16 of the secondary coil 12.

The relationship between the reception voltage VR and the X-direction or Y-direction offset at a prescribed gap length is determined previously by experimentation, and the vehicle determines the corresponding offset from the reception voltage VR, and presents an indicator display corresponding to this offset, on the display unit 520.

FIG. 2 depicts an example in which the power receiving unit 100 is arranged in the vehicle in such a manner that the Y direction in FIG. 3 to FIG. 6 coincides with the direction of travel of the vehicle, but the power receiving unit 100 may be arranged in the vehicle in such a manner that the X direction coincides with the direction of travel of the vehicle.

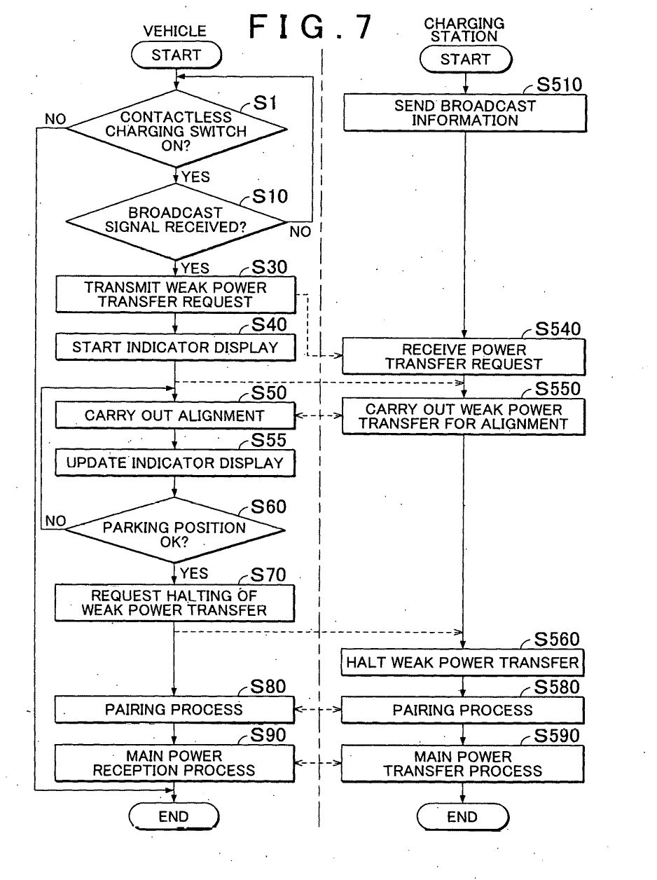

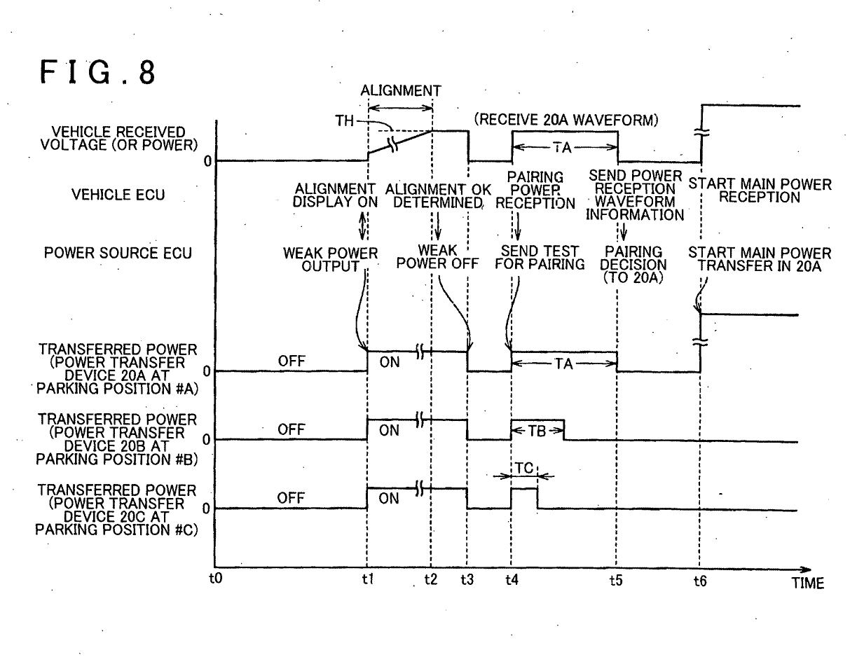

Next, the procedure of contactless power transfer will be described. FIG. 7 is a flowchart for describing an overview of the processing which is implemented by the vehicle 10 and the charging station 90 when contactless power transfer is carried out. FIG. 8 is a timing chart which represents change in the transferred power and the received voltage, which vary over the course of the processing in FIG. 7.

The description below refers to FIG. 1 and FIG. 7 and FIG. 8. Here, a case is described in which a route of travel is selected to align the vehicle 10 in such a manner that power is transferred from the power transferring unit 700A of the charging station 90. In the flowchart shown in FIG. 7, firstly, in step S510, the power source ECU 800 of the charging station 90 outputs a broadcast signal, which is a signal indicating a status capable of charging in the peripheral area, when it is determined that at least one of the parking bays A to C is free, based on the outputs from the sensors 21A to 21C.

In step S1, the vehicle 10 determines whether or not the contactless charging switch 130 provided in the vehicle 10 is “ON”. The contactless charging switch 130 is “ON” when not operated by the user, and is set to “OFF” when operated by the user.

The vehicle terminates processing when it is detected that the contactless charging switch 130 is “OFF”. Accordingly, it is possible to suppress display of the indicators, and the like, described below, on the display unit, by the user switching the contactless charging switch 130 to “OFF”, immediately after charging, for example.

In step S10, the vehicle ECU 500 of the vehicle 10 determines whether or not a broadcast signal has been received from the charging station 90. When it is determined that a broadcast signal has not been received, then the processing returns to step S1 described above.

In step S1, when it is determined that the vehicle 10 has received a broadcast signal, then the processing advances to step S30, and the vehicle 10 transmits a weak power request to the charging station 90.

When the charging station 90 has received a weak power request from the vehicle 10 in step S540, then in step S550, at least weak power is supplied to the power transferring devices 20A to 20C where the Vehicle is not parked. When the sensors 21A to 21C are not provided, then the power source ECU 800 of the charging station cannot identify which parking position the vehicle is parked in. Consequently, a weak power is transferred from all of the power transfer devices 20A, 20B and 20C which are not carrying out main charging to a vehicle.

In step S40, the vehicle ECU 500 starts display of an indicator for alignment, on the display unit 520, based on the received voltage upon receiving weak power from the power transferring devices 20A to 20C. The liquid crystal panel of the car navigation system is used as the display unit 520, for example, but it is also possible to use another display device.

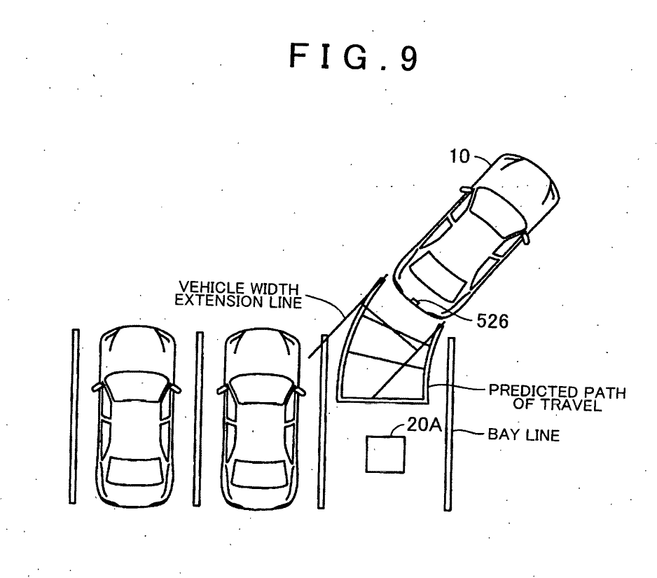

FIG. 9 is a diagram showing a state of carrying out alignment while the vehicle is reversing. FIG. 10 is a diagram showing a state where an indicator is displayed on the display unit.

The description below refers to FIG. 9 and FIG. 10. When the shift lever of the vehicle 10 is set to the reverse (R) position, then a video image captured by a camera 526 provided in the rear portion of the vehicle is displayed on the display unit 520. An indicator 524 which represents the positional relationship between the power receiving unit and the power transferring unit is displayed on the display unit 520.

A vehicle width extension line 522 and a predicted path line 523 arc displayed on the display unit 520. In this case, an icon 521 is displayed when the parking assistance device is operating.

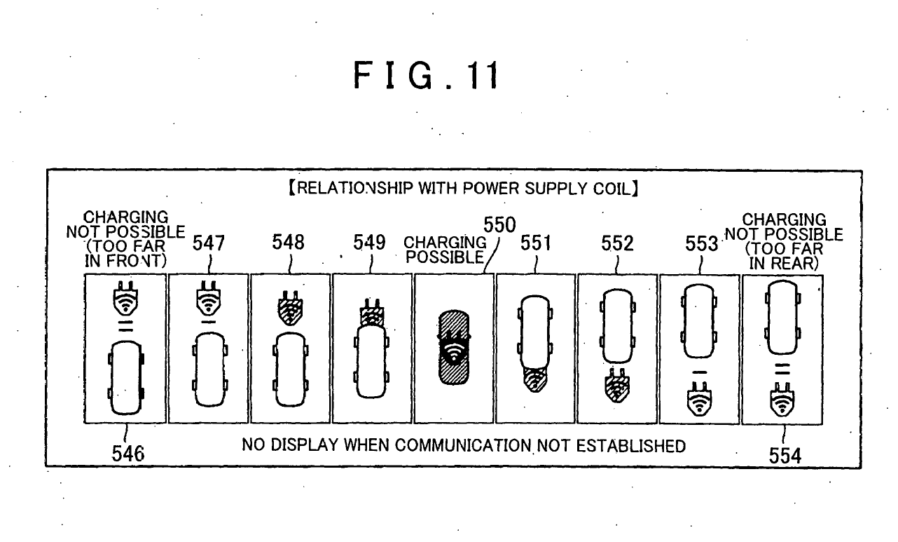

FIG. 11 is a diagram for describing changes in the indicator display. Referring to FIG. 11, the chargeable status is indicated by the display 550. The fact that the power transferring unit is distanced greatly from the power receiving unit in the front direction of the vehicle is indicated by display 546. A state where the power transferring unit approaches the power receiving unit is indicated in sequence by the displays 547, 548 and 549.

Conversely, the display 554 indicates a state where the power transferring unit is greatly distanced from the power receiving unit in the rear direction of the vehicle. A state where the power transferring unit approaches the power receiving unit is indicated in sequence by the displays 553, 552 and 551. In the screen example shown in FIG. 10, the vehicle is reversing and is still greatly distanced from the parking position, and therefore the display 554 is shown as the indicator 524.

The displays 548 to 552 show states where the power reception intensity is considerably strong, and are depicted in such a manner that the brightness of all or a part of the indicator is greater than when depicting the displays 546, 547, 553 and 554.

In step S50, the vehicle 10 carries out alignment by the vehicle 10 being moved either manually or automatically (see-time point t1 in FIG. 8). During alignment, the vehicle ECU 500 electrically connects the relay 202 and acquires the magnitude of the received voltage VR which is generated at both ends of the resistance 201 and is detected by the voltage sensor 203. Since the voltage is smaller than during actual power transfer, then the vehicle ECU 500 switches off the relay 210 so that the voltage detection is not affected by the power storage device 300.

When the vehicle 10 moves, the indicator display is updated at step S55, and as the power receiving unit 100 of the vehicle 10 and the power transferring unit 700A approach each other, the display changes from display 554, in the sequence, 553, 552, 551 and 550, in FIG. 11. This switching of the display is executed based on the received voltage VR.

In step S60, the vehicle ECU 500 displays any one of the displays 548 to 552, as an indicator, on the display unit 520, when the magnitude of the received voltage VR is greater than a threshold value TH. Consequently, the user recognizes that alignment between the power receiving unit 100 of the vehicle 10 and the power transferring unit 700A of the charging station 90 has been performed successfully. Thereupon, when the user notifies that the parking position is OK by pressing the parking switch in the vehicle 10, then the processing advances to step S70 (see time point t2 in FIG. 8).

In step S70, the vehicle ECU 500 transmits a request to stop transmission of weak power for alignment, to the charging station 90. In step S560, the power source ECU 800 of the charging station 90 receives the request to halt weak power transfer, and the weak power transfer for alignment by the power transfer devices 20A, 20B and 20C ends (see time point t3 in FIG. 8).

The secondary-side voltage (received voltage VR) changes with respect to the fixed primary-side voltage (the output voltage from the power transfer devices 20A, 20B and 20C) in accordance with the distance between the primary coils of the power transfer devices 20A, 20B and 20C, and the secondary coil of the power reception device 120. Therefore, the relationship between the received voltage VR, and the difference between the horizontal-direction positions of the centre of gravity O1 of the primary coil and the centre of gravity O2 of the secondary coil, is measured in advance, and the received voltage VR corresponding to the allowable difference between the horizontal-direction positions of the centre of gravity O1 of the primary coil and the centre of gravity O2 of the secondary coil is set as a threshold value TH.

In step S80 and step S580, the vehicle ECU 500 and the power source ECU 800 carry out a pairing process for identifying which of the power transfer devices 20A, 20B and 20C the vehicle has been aligned with. The power source ECU 800 alters the continuous on time of power transfer, between each of the power transfer devices. In other words, the power transfer device 20A switches on power transfer for a time TA, the power transfer device 20B switches on power transfer for a time TB, and the power transfer device 20C switches on power transfer for a time TC (see time point t4 in FIG. 8).

The vehicle ECU 500 reports the continuous on time of the received power, to the power source ECU 800. In the example in FIG. 12, the power reception device 120 receives transferred power from the power transfer device 20A. The vehicle ECU 500 reports the continuous on time of the received power, to the power source ECU 800. By this means, the power source ECU 800 can identify that the vehicle has been aligned with the power transfer device 20A.

In step S590, the charging station 90 carries out a main power transfer process by the power transfer device with which the vehicle has been aligned and for which identification by pairing has been completed (see time point t6 in FIG. 8). In the example in FIG. 8, the power transfer device 20A carries out a power transfer process. In step S90, the vehicle 10 charges the power storage device 300 with the received power, by carrying out a main power reception process by the power reception device 120. When charging of the power storage device 300 has been completed, the processing by the vehicle and the charging station is ended.

As described above, in this embodiment, since the positional relationship between the power receiving unit and the power transferring unit is indicated on the display unit 520 after the vehicle 10 has received a signal from the charging station, then the time during which excessive information is presented becomes short and the driver can operate the vehicle easily, compared to a case where information about the positional relationship is displayed at all times. This invention is not limited to the embodiment described above, and may include modifications such as the following, for example.

FIG. 12 is a diagram for describing modifications of the pairing process. In FIG. 12, the power source ECU 800 alters the on/off switching cycle of the transferred power, between each of the power transfer devices. More specifically, the power transfer device 20A switches the transferred power on and off at a cycle of ΔTA, the power transfer device 20B switches the transferred power on and off at a cycle of ΔTB, and the power transfer device 20C switches the transferred power on and off at a cycle of ΔTC (see time points t4 and t5 on FIG. 12).

The vehicle ECU 500 reports the on/off switching cycle of the received power, to the power source ECU 800. In the example in FIG. 12, the power reception device 120 receives transferred power from the power transfer device 20A. The vehicle ECU 500 reports to the power source ECU 800 that the on/off switching cycle of the received power is ΔTB. In this way, the power source ECU 800 can tell that the vehicle has been aligned with the power transfer device 20A (see time point t5 in FIG. 12).

The modification example in FIG. 12 is a modification example in which pairing is carried out using the transferred power, but the invention is not limited to this. Pairing is possible by technologies of various types, for example, pairing may be carried out by using radio frequency identification (RFID) technology, and providing an RFID tag and an RFID reader respectively in the vehicle and the power transferring unit.

1. A contactless power transfer system, comprising:
a charging station including a first communication unit and a power transferring unit; and
a vehicle including a second communication unit, a power receiving unit, a display unit and an electronic control unit, the second communication unit being configured to communicate with the first communication unit, the power receiving unit being configured to contactlessly receive electric power from the power transferring unit, the display unit being configured to indicate a relative positional relationship between the power receiving unit and the power transferring unit, and the electronic control unit being configured to control the second communication unit, the power receiving unit and the display unit, wherein
a vehicle parking region is a region in which the vehicle is positioned in a state where the power receiving unit is disposed so as to face the power transferring unit, the first communication unit is configured to output a first signal so that the first signal reaches the outside of the vehicle parking region and the second communication unit is configured to receive the first signal from the charging station at outside the vehicle parking region, and the electronic control unit is configured to start a display of the positional relationship on the display unit, when the second communication unit receives the first signal, wherein
a plurality of parking bays are provided in the charging station, and the first communication unit of the charging station is configured to output the first signal when determination is made that another vehicle is not parked over at least one of the power transferring unit.

2. (canceled)

3. The contactless power transfer system according to claim 1, wherein
the charging station includes a detection unit configured to detect the vehicle positioned over the power transferring unit.

4. The contactless power transfer system according to claim 1, wherein the second communication unit of the vehicle is configured to output a second signal upon receiving the first signal, the electronic control unit is configured to transfer electric power from the power transferring unit to the power receiving unit when the first communication unit of the charging station receives the second signal, and the electronic control unit is configured to display the positional relationship between the power receiving unit and the power transferring unit on the display unit based on a received voltage generated by the electric power received by the power receiving unit.

5. The contactless power transfer system according to claim 4, wherein
the vehicle includes a contactless charging switch operated by a user; and
the electronic control unit is configured to output the second signal to the second communication unit and perform a display on the display unit when the second communication unit receives the first signal while the contactless charging switch is on.

6. The contactless power transfer system according to claim 1, wherein
the charging station includes a plurality of the power transferring units,
the electronic control unit is configured to perform a pairing process with the charging station, when alignment of the power receiving unit with the one of the plurality of power transferring units has been completed after starting the display of the positional relationship on the display unit, and
in the pairing process, the charging station is configured to identify which one of the plurality of power transferring units has been aligned with the power receiving unit.

7. The contactless power transfer system according to claim 6, wherein
the pairing process includes processing in which a plurality of mutually different pattern power transfers are performed respectively from the plurality of power transferring units, and the pairing process includes processing in which a signal corresponding to the pattern power transfer received by the power receiving unit is transmitted from the second communication unit to the first communication unit.

8. The contactless power transfer system according to claim 7, wherein
the plurality of pattern power transfers are power transfers in which electric power is transferred so as to repeat on and off switching in mutually different patterns, during a prescribed time period.

9. The contactless power transfer system according to claim 7, wherein
the plurality of pattern power transfers are power transfers in which electric power is transferred for mutually different power transfer times, during a prescribed time period.

10. The contactless power transfer system according to claim 1, wherein
the electronic control unit is configured not to display an image representing the positional relationship on the display unit, before establishing a communication between the first communication unit and the second communication unit.

11. A vehicle capable of receiving electric power from a charging station including a first communication unit and a power transferring unit,
the vehicle comprising:
a second communication unit configured to communicate with the first communication unit from a position that is distant from a parking bay;
a power receiving unit configured to contactlessly receive electric power from the power transferring unit;
a display unit configured to display a relative positional relationship between the power receiving unit and the power transferring unit; and
an electronic control unit configured to control the second communication unit, the power receiving unit and the display unit, wherein
the parking bay is a region in which the vehicle is positioned in a state where the power receiving unit is disposed so as to face a power transferring unit, the first communication unit is configured to output a first signal so that the first signal reaches the outside of the parking bay and the second communication unit is configured to receive the first signal from the charging station at outside the parking bay, and the electronic control unit is configured to start a display of the positional relationship on the display unit, when the second communication unit receives the first signal, wherein
a plurality of parking bays are provided in the charging station, and the first communication unit of the charging station is configured to output the first signal when determination is made that another vehicle is not parked over at least one of the power transferring unit.
